(19) United States
(12) Patent Application Publication
(10) Pub. No.: US 2006/0223713 A1
(43) Pub. Date: Oct. 5, 2006

(54) Method of completing a well with hydrate inhibitors

(75) Inventors: Marek K. Pakulski, The Woodlands, TX (US); Qi Qu, Spring, TX (US); Rick G. Pearcy, Tomball, TX (US)

Correspondence Address: JONES & SMITH, LLP, THE RIVIANA BUILDING, 2777 ALLEN PARKWAY, SUITE 800, HOUSTON, TX, 77019-2141, US

(73) Assignee: BJ Services Company, Houston, TX (US)

(21) Appl. No.: 11/098,967

(22) Filed: Apr. 5, 2005

(51) Int. Cl. C09K 8/32; C09K 8/22

(52) U.S. Cl. 507/132

(57) ABSTRACT

Compositions for inhibiting the formation and/or growth of gas hydrates contain at least one low dosage kinetic hydrate inhibitor and at least one thermodynamic hydrate inhibitor. Kinetic hydrate inhibitors include aminated polyalkylene glycols of the formula:
R¹R²N[(A)ₐ—(B)_{b}—(A)_{c}—(CH₂)_{d}—CH(R)—NR¹]ₙR² (I) wherein:
each A is independently selected from —CH₂CH(CH₃)O— or —CH(CH₃)CH₂O—;
B is —CH₂CH₂O—; a+b+c is from 1 to about 100;
R is —H or CH₃
each R¹ and R² are independently selected from the group consisting of —H, —CH₃, —CH₂—CH₂—OH and CH(CH₃)—CH₂—OH; d is from 1 to about 6; and n is from 1 to about 4. Such gas hydrate inhibitor compositions are particularly efficacious in the treatment of media susceptible to gas hydrate formation that may occur during the extraction of natural gas and petroleum fluids, such as low boiling hydrocarbons, from a producing well, during transportation of such gas and fluids, and during processing of such gas and fluids.

### FIELD OF THE INVENTION

The present invention relates generally to completion fluids containing at least one low dosage hydrate inhibitor and at least one thermodynamic hydrate inhibitor. Such fluids effectively inhibit and/or suppress the formation and growth of gas hydrates during well treating operations.

### BACKGROUND OF THE INVENTION

Gas hydrates form when water molecules crystallize around gas molecules, such as C₁-C₇ hydrocarbons, nitrogen, carbon dioxide and hydrogen sulfide. Depending on the pressure and gaseous composition, gas hydrates may accumulate at any place where water coexists with natural gas at temperatures as high as 30° C. (about 80° F.). Gas hydrate formation presents particular problems in the production, transportation, and processing of hydrocarbons and is especially damaging during well completion, especially for offshore deepwater oil/gas well completions.

Hydrate formation is often prevented where the completion fluid contains high-density brine since highly concentrated salt solutions are often very efficient thermodynamic hydrate inhibitors. However, in ultra-deep offshore waters, low density completion fluids are often used and hydrate formation becomes a particularly acute problem. These low density fluids must not impart damage to oil and gas bearing formations and further not impede future gas or oil output from the well. In a typical deepwater oil/gas well, such fluids must function under significant pressures and low mudline temperatures. Typically, the mudline temperature is as low as about 40° F. or less and the pressure is often as high as 10,000 psi or above. Such conditions create a favorable environment for the formation of gas hydrates.

One solution proposed for such deepwater wells is to pump massive amounts of thermodynamic hydrate inhibitors—such as methanol, ethanol, glycols, glycol ethers and polyglycols—into well and production lines. This causes destabilization of the hydrates and effectively lowers the temperature for hydrate formation. A thermodynamic hydrate inhibitor functions to lower the energy state of the free gas and water to a more ordered lowered energy state than that of the formed hydrate and thermodynamic hydrate inhibitor. Thus, the use of thermodynamic hydrate inhibitors in deepwater oil/gas wells having lower temperature and high-pressure conditions causes the formation of stronger bonds between the thermodynamic hydrate inhibitor and water versus gas and water. Unfortunately, the use of such massive amounts of thermodynamic inhibitors creates problems like oxygen corrosion and solvent induced scaling. Further, the addition of large quantities of thermodynamic hydrate inhibitors increases the complexity of fluid placement and causes greater safety and environmental concerns since such substances are flammable. In other cases, significant cost increase is associated with the use of such materials.

Alternatives for efficient low density well treatment fluids for deep water platforms are therefore desired.

### SUMMARY OF THE INVENTION

Completion fluids containing at least one low dosage hydrate inhibitor and at least one thermodynamic hydrate inhibitor are highly effective in the inhibition and/or suppression of the formation and growth of gas hydrates, especially in deepwater gas/oil wells. In a preferred mode, the gas hydrate inhibitor compositions of the invention contain low density brines. The invention further relates to methods for inhibiting the formation and/or growth of gas hydrates in media susceptible to gas hydrate formations.

Suitable low dosage hydrate inhibitors include kinetic hydrate inhibitors as well as antiagglomerants. Preferred kinetic hydrate inhibitors include aminated polyalkylene glycols, such as those of the formula:
R¹R²N[(A)ₐ—(B)_{b}—(A)_{c}—(CH₂)_{d}—CH(R)—NR¹]ₙR² (I)
wherein:
each A is independently selected from —CH₂CH(CH₃)O— or —CH(CH₃)CH₂O—;
B is —CH₂CH₂O—;
a+b+c is from 1 to about 100;
R is —H or CH₃
each R¹ and R² is independently selected from the group consisting of —H, —CH₃, —CH₂—CH₂—OH and CH(CH₃)—CH₂—OH;
d is from 1 to about 6; and
n is from 1 to about 4.

The use of the gas hydrate inhibitor compositions of the invention significantly reduces the amount of thermodynamic hydrate inhibitors normally employed in gas hydrate inhibitor compositions. This, in turn, leads to safer well treating operations and lower costs.

### BRIEF DESCRIPTION OF THE DRAWINGS

In order to more fully understand the drawings referred to in the detailed description of the present invention, a brief description of each drawing is presented, in which:

FIG. 1 illustrates improvements in hydrate inhibition using the composition of the invention over the compositions of the prior art.

### DETAILED DESCRIPTION OF THE PREFERRED EMBODIMENTS

Completion fluids containing at least one low dosage hydrate inhibitor (LDHI) and at least one thermodynamic hydrate inhibitor (THI) are highly effective in the inhibition and/or suppression of the formation and growth of gas hydrates in media susceptible to gas hydrate formation. The compositions have particular applicability controlling the formation of gas hydrates in fluid mixtures containing water and guest molecules in deepwater gas/oil wells.

In practice, the gas inhibitor formulation is admixed with the fluid mixture in order to inhibit the formation and/or growth of gas hydrates in the fluid mixture. Alternatively, the formulation may be introduced into a pipe containing a petroleum fluid stream having hydrate forming constituents.

The gas hydrate formulations described herein tend to concentrate at the water/hydrocarbon interface. It is at this interface where gas hydrates typically form. The formulations are also useful in preventing growth of gas hydrates that are already formed.

The LDHI and THI are typically contained in low density salt brine. The resulting completion fluid provides a low density, low concentration salt brine which exhibits thermodynamic hydrate inhibition properties and anti-agglomerate properties. Such brines, upon placement into the wellbore of the well, are especially effective in preventing the formation of gas hydrates under extreme conditions.

The amount of LDHI in the gas hydrate composition is typically between from about 0.01 to about 5.0 percent by weight of water (or brine), preferably from about 0.1 to about 2.0 percent by weight of water (or brine), and the amount of THI in the gas hydrate composition is typically between from about 1 to about 50 percent by weight of water (or brine), preferably from about 2 to about 10 percent by weight of water (or brine). Typically, the weight ratio of LDHI:THI in the gas hydrate composition is between from about 1:100 to about 1:10, preferably from about 1:50 to about 1:20.

Further, the use of LDHI with THI significantly reduces the need for the use of organic alcohols as THI in the completion fluid. As a result, wellsite operations proceed more safely when the compositions herein are employed. Further, the use of such compositions provides for lower costs since costly solvents are minimized.

LDHIs are defined as non-thermodynamic hydrate inhibitors which do not lower the energy state of the free gas and water to the more ordered lowered energy state created by hydrate formation. Such inhibitors interfere with the hydrate formation process by blocking the hydrate-growing site; thereby retarding the growth of hydrate crystals. Such inhibitors may be categorized into antiagglomerants (AA) and hydrate growth inhibitors. Anti-agglomerants are those compounds capable of being absorbed onto the surfaces of the hydrate crystals, thereby eliminating or retarding the agglomeration of hydrate crystals.

Hydrate growth inhibitors may be subdivided into kinetic hydrate inhibitors (KHI) and threshold hydrate inhibitors (THI). In general, LDHIs inhibit gas hydrate formation by coating and commingling with hydrate crystals, thereby interfering with the growth and the agglomeration of small hydrate particles into larger ones. As a result, plugging of the gas well and equipment within the well is minimized or eliminated.

Suitable kinetic inhibitors include those known in the art, such as polyvinylpyrrolidone, polyvinylcaprolactam or a polyvinylpyrrolidone caprolactam dimethylaminoethylmethacrylate copolymer. Such inhibitors further may contain a caprolactam ring attached to a polymeric backbone and copolymerized with esters, amides or polyethers, such as those disclosed in U.S. Pat. No. 6,214,091.

Preferred kinetic inhibitors are aminated polyalkylene glycols of the formula:
R¹R²N[(A)ₐ—(B)_{b}—(A)_{c}—(CH₂)_{d}—CH(R)—NR¹]ₙR² (I)
wherein:
each A is independently selected from —CH₂CH(CH₃)O— or —CH(CH₃)CH₂O—;
B is —CH₂CH₂O—;
a+b+c is from 1 to about 100;
R is —H or CH₃
each R¹ and R² are independently selected from the group consisting of —H, —CH₃, —CH₂—CH₂—OH and CH(CH₃)—CH₂—OH;
d is from 1 to about 6; and
n is from 1 to about 4.

Especially preferred are those aminated polyalkylene glycols of the formulae:
R¹HN(CH₂CHRO)ⱼ(CH₂CHR)NHR¹ (II)
as well as those aminated polyalkylene glycols of the formula
H₂N(CH₂CHRO)ₐ(CH₂CH₂O)_{b}(CH₂CHR)NH₂ (III)
wherein a+b is from 1 to about 100; and
j is from 1 to about 100.
   In an especially preferred embodiment, each R¹ and R² is —H; a, b, and c are independently selected from 0 or 1; and n is 1. More preferred are mixtures of the aminated polyalkylene glycols of formulae (II) and (III).

Included as antiagglomerants are those known in the art and include substituted quaternary compounds, such as those disclosed in U.S. Pat. Nos. 6,152,993; 6,015,929; and 6,025,302, herein incorporated by reference.

The brine is preferably lower density brine. Preferred are those brines having a density lower than 12.5 pounds per gallon (ppg) (or 1.5 g/cm³), more preferably lower than 10.0 ppg. Such brines are typically formulated with at least one salt selected from NH₄Cl, CsCl, CsBr, NaCl, NaBr, KCl, KBr, HCOONa, HCOOK, HCOOCs, CH₃COONa, CH₃COOK, CaCl₂, CaBr₂, and ZnBr₂.

The thermodynamic hydrate inhibitor is any of those conventionally known in the art, such as an alcohol, glycol, polyglycol or glycol ether or a mixture thereof. Preferred thermodynamic hydrate inhibitors include methanol and ethanol.

When formulated as a packer fluid, the formulation may contain an organic solvent. The packer fluid may be placed in the casing/tubing annulus to provide either the hydrostatic pressure to control the well or sufficient hydrostatic pressure to meet the desired design criteria for completion.

The gas hydrate composition of the invention may be injected into a downhole location in a producing well to control hydrate formation in fluids being produced through the well. Likewise, the composition may be injected into the produced fluid stream at a wellhead location, or even into piping extending through a riser, through which produced fluids are transported in offshore producing operations from the ocean floor to the offshore producing facility located at or above the surface of the water. Additionally, the composition may be injected into a fluid mixture prior to the transportation of the fluid mixture, such as via a subsea pipeline from an offshore producing location to an onshore gathering and/or processing facility.

Incorporation or admixing of the gas hydrate composition of the invention into the fluid mixture may be aided by mechanical means known in the art, including but not limited to static in-line mixers on a pipeline or an atomizing injection. In most pipeline transportation applications, however, sufficient mixture and contacting will occur due to the turbulent nature of the fluid flow, and mechanical mixing aids may not be necessary.

Generally, the gas hydrate composition will be admixed with the fluid mixture in an amount of from about 0.01% to about 5% by weight of the water present in the fluid mixture, preferably from about 0.05% to about 1% by weight of the water present in the fluid mixture, and more preferably in an amount of from about 0.025% to about 0.5% by weight of the water present in the fluid mixture. However, the amount of gas hydrate composition required to be admixed with any particular fluid mixture may vary, depending upon the composition of the fluid mixture, as well as the temperature and pressure of the fluid mixture system. Knowing such parameters, an effective amount of gas hydrate composition can be determined by methods known in the art.

For example, the subcooling temperature, i.e., the temperature at which gas hydrates begin to form, can be determined using commercially available computer programs such as those available from the Colorado School of Mines in Denver, Colo., or from CALSEP A/S in Denmark. The differential between the fluid mixture system's temperature and the subcooling temperature at a given pressure can then be determined. With this information, the operator can estimate whether to increase or decrease the general recommended dosage of gas hydrate inhibitor for a fluid mixture of a given composition. Alternatively, an effective amount of inhibitor can be determined as compared to the amount of THI that would be required to protect a fluid mixture system against gas hydrate formation. Typically, a THI is added in an amount of between 10% and 30% of the water volume of a given fluid mixture system. This amount may vary, however, depending on the composition, temperature, and pressure parameters of the fluid mixture system. The gas hydrate inhibitors of the present application are generally effective in amounts of from about 1/100 to about 1/1000 of THI required to treat a given fluid mixture system.

The following examples will illustrate the practice of the present invention in their preferred embodiments.

### EXAMPLES

The LDHI was a methanolic solution containing:

(i.) about one third by weight of the aminated glycol RHN—(CH₂)₂(OCH₂CH₂)ₙ—NHR where R is H, —CH₂CH₂OH or —CH(CH₃)CH₂OH and n=1-10; and

(ii.) about two thirds by weight of the aminated glycol RHN—CH₂CH(CH₃) [OCH₂CH(CH₃)]ₙ—NHR, where R is H, —CH₂CH₂OH or —CH(CH₃)CH₂OH and n=1-10 These chemicals are available from BASF or Huntsman Corporation under the tradename of Jeffamine. Four fluids were prepared to meet the low density (8.6 and 8.7 ppg) requirements by mixing the components of Tables I through IV at room temperature. The Tables further designate the density of each fluid.

TABLE I

| 8.6 ppg | Weight % |
|---|---|
| NaCl (dry) | 13.4% |
| Methanol | 21.9% |
| Water | 64.6% |

TABLE II

| 8.6 ppg | |
|---|---|
| w/GHI-7190 | Weight % |
| NaCl (dry) | 13.4% |
| Methanol | 21.9% |
| Water | 64.1% |
| GHI-7190 | 0.5% |

TABLE III

| 8.7 ppg | Weight % |
|---|---|
| NaCl (dry) | 10.4% |
| Methanol | 17.5% |
| EGMBE | 22.2% |
| Water | 50.0% |

TABLE IV

| 8.7 ppg | |
|---|---|
| w/GHI-7190 | Weight % |
| NaCl (dry) | 10.4% |
| Methanol | 17.5% |
| EGMBE | 22.2% |
| Water | 49.4% |
| GHI-7190 | 0.5% |

A simulated gas hydrate formation test procedure was used for the testing of the efficiency of the fluids of the invention. The hydrate inhibition laboratory testing was performed in a stainless steel autoclave (hydrate cell) at the constant temperature of 2.5° C. and 6,500 kPa initial pressure, using “Green Canyon” natural gas mixture, as reported in Lovell, D., Pakulski, M., “Hydrate Inhibition in Gas Wells Treated with Two Low Dosage Hydrate Inhibitors”, SPE 75668, Presented at the SPE Gas Technology Symposium in Calgary, Alberta, Canada, Apr. 30-May 2, 2002. The total concentration of active materials in each experiment was 0.3% and estimated subcooling temperature of 14° C. Hydrate inhibition was evaluated with DBR hydrate simulation software. The final fluid prohibited the formation of hydrates at least at 35° F. (1.7° C.) and 4,000 psi.

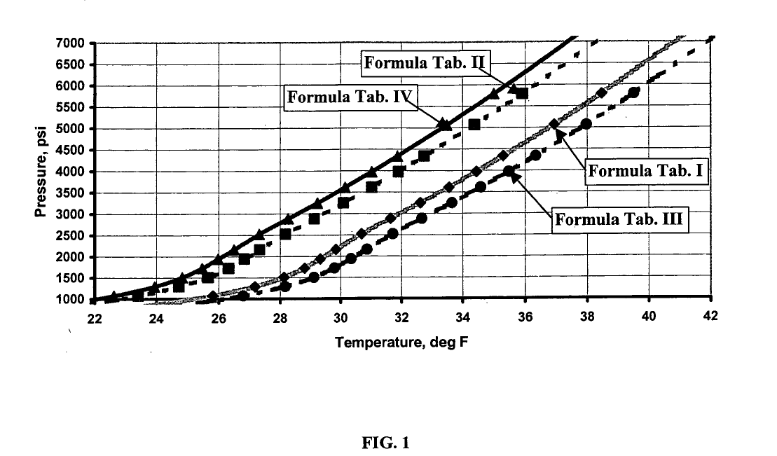

FIG. 1 shows the hydrate formation equilibrium curve corresponding to each fluid. The Curves #s. 1, 2, 3, and 4 correspond to the formulations set forth in Tables I, II, III, and IV, respectively. A comparison of Curve #1 vs. Curve #2 denotes a significant reduction of hydrate formation using the LDHI. Curve #3 versus Curve #4 illustrates similar results. Without the addition of 0.5% of LDHI, the fluid barely met the required hydrate inhibition temperature and pressure. The addition of 0.5% of LDHI provided a 5° F. safety margin by moving the hydrate envelope toward the lower temperature/high pressure region. In contrast, the addition of LDHI ensured the safe use of such low density completion packer fluids without the formation of gas hydrates.

From the foregoing, it will be observed that other embodiments within the scope of the claims herein will be apparent to one skilled in the art from consideration of the specification. It is intended that the foregoing examples be considered exemplary only, with the scope and spirit of the invention being indicated by the claims which follow.

What is claimed is:

1. A method for completing a hydrocarbon-containing fluid well comprising placing in the wellbore of the well a completion fluid comprising a thermodynamic hydrate inhibitor and a low dosage hydrate inhibitor.

2. The method of claim 1, wherein the low dosage hydrate inhibitor is a kinetic hydrate inhibitor.

3. The method of claim 2, wherein the kinetic hydrate inhibitor is an aminated polyalkylene glycol of the formula:
R¹R²N[(A)ₐ—(B)_{b}—(A)_{c}—(CH₂)_{d}—CH(R)—NR¹]ₙR² (I)
wherein:
each A is independently selected from —CH₂CH(CH₃)O— or —CH(CH₃)CH₂O—;
B is —CH₂CH₂O—;
a+b+c is from 1 to about 100;
R is —H or CH₃
each R¹ and R² are independently selected from the group consisting of —H, —CH₃, —CH₂—CH₂—OH and CH(CH₃)—CH₂—OH;
d is from 1 to about 6; and
n is from 1 to about 4.

4. The method of claim 3, wherein the kinetic hydrate inhibitor is selected from the group consisting of:
(i.) R¹HN(CH₂CHRO)ⱼ(CH₂CHR)NHR¹; and
(ii.) H₂N (CH₂CHRO)ₐ (CH₂CH₂O)_{b}(CH₂CHR)NH₂
and mixtures thereof
wherein a+b is from 1 to about 100; and
j is from 1 to about 100.

5. The method of claim 3, wherein each R¹ and R² is —H; a, b, and c are independently selected from 0 or 1 and n is 1.

6. The method of claim 1, wherein the thermodynamic hydrate inhibitor is an alcohol, glycol, polyglycol or glycol ether or a mixture thereof.

7. The method of claim 3, wherein the thermodynamic hydrate inhibitor is an alcohol, glycol, polyglycol or glycol ether or a mixture thereof.

8. The method of claim 7, wherein the thermodynamic hydrate inhibitor is methanol or ethanol.

9. The method of claim 1, wherein the completion fluid is a packer fluid.

10. The method of claim 1, wherein the amount of low dosage hydrate inhibitor in the completion fluid is between from about 0.01 to about 5% by weight of water.

11. The method of claim 1, wherein the completion fluid contains a brine having a density of 12.5 ppg or less.

12. A method for suppressing the formation of hydrates during the deepwater completion of a well comprising introducing into the well a completion fluid containing a gas hydrate inhibitor comprising a thermodynamic hydrate inhibitor and a low dosage hydrate inhibitor, wherein the low dosage hydrate inhibitor is an aminated polyalkylene glycol selected from the group consisting of:
R¹R²N[(A)ₐ—(B)_{b}—(A)_{c}—(CH₂)_{d}—CH(R)—NR¹]ₙR² (I)
wherein:
each A is independently selected from —CH₂CH(CH₃)O— or —CH(CH₃)CH₂O—;
B is —CH₂CH₂O—;
a+b+c is from 1 to about 100;
R is —H or CH₃
each R¹ and R² are independently selected from the group consisting of —H, —CH₃, —CH₂—CH₂—OH and CH(CH₃)—CH₂—OH;
d is from 1 to about 6; and
n is from 1 to about 4.

13. The method of claim 12, wherein the kinetic hydrate inhibitor is selected from the group consisting of:
(i.) R¹HN(CH₂CHRO)ⱼ(CH₂CHR)NHR¹; and
(ii.) H₂N (CH₂CHRO)ₐ(CH₂CH₂O)_{b}(CH₂CHR)NH₂
and mixtures thereof
wherein a+b is from 1 to about 100; and
j is from 1 to about 100.

14. The method of claim 12, wherein the thermodynamic hydrate inhibitor is an alcohol, glycol, polyglycol or glycol ether or a mixture thereof.

15. The method of claim 14, wherein the thermodynamic hydrate inhibitor is methanol or ethanol.

16. The method of claim 12, wherein the completion fluid contains a brine having a density of 12.5 ppg or less.

17. The method of claim 16, wherein the completion fluid is a packer fluid.

18. A method for inhibiting the formation or growth of gas hydrates in a pipe containing a petroleum fluid stream having hydrate forming constituents, comprising admixing with the petroleum fluid stream a composition comprising a thermodynamic hydrate inhibitor and a low dosage hydrate inhibitor.

19. The method of claim 18, wherein the low dosage hydrate inhibitor is a kinetic hydrate inhibitor.

20. The method of claim 19, wherein the kinetic hydrate inhibitor is an aminated polyalkylene glycol selected from the group consisting of:
R¹R²N[(A)ₐ—(B)_{b}—(A)_{c}—(CH₂)_{d}—CH(R)—NR¹]ₙR² (I)
wherein:
each A is independently selected from —CH₂CH(CH₃)O— or —CH(CH₃)CH₂O—;
B is —CH₂CH₂O—;
a+b+c is from 1 to about 100;
R is —H or CH₃
each R¹ and R² are independently selected from the group consisting of —H, —CH₃, —CH₂—CH₂—OH and CH(CH₃)—CH₂—OH;
d is from 1 to about 6; and
n is from 1 to about 4.

21. The method of claim 20, wherein the kinetic hydrate inhibitor is selected from the group consisting of:
(i.) R¹HN(CH₂CHRO)ⱼ(CH₂CHR)NHR¹; and
(ii.) H₂N(CH₂CHRO)ₐ(CH₂CH₂O)_{b}(CH₂CHR)NH₂
and mixtures thereof
wherein a+b is from 1 to about 100; and
j is from 1 to about 100.

22. The method of claim 18, wherein the low dosage hydrate inhibitor is an anti-agglomerate.
